(19) United States
(12) Patent Application Publication
(10) Pub. No.: US 2013/0241816 A1
(43) Pub. Date: Sep. 19, 2013

(54) ELECTROPHORETIC DISPLAY APPARATUS

(71) Applicants: Wen-Chung Tang, Hsinchu (TW); Fang-An Shu, Hsinchu (TW); Yao- Chou Tsai, Hsinchu (TW); Ted-Hong Shinn, Hsinchu (TW)

(72) Inventors: Wen-Chung Tang, Hsinchu (TW); Fang-An Shu, Hsinchu (TW); Yao- Chou Tsai, Hsinchu (TW); Ted-Hong Shinn, Hsinchu (TW)

(73) Assignee: E INK HOLDINGS INC., Hsinchu (TW)

(21) Appl. No.: 13/615,694

(22) Filed: Sep. 14, 2012

(30) Foreign Application Priority Data
Mar. 16, 2012 (TW) 101109090

(51) Int. Cl. G09G 3/34

(52) U.S. Cl. 345/107

(57) ABSTRACT

An electrophoretic display apparatus including a substrate and an electrophoretic display film is provided. The substrate has multiple pixel units, each the pixel unit has a transparent region and a reflective region and each the pixel unit includes a pixel electrode and a reflective layer. The pixel electrode is located in the transparent region and the reflective region. The reflective layer is disposed on the pixel electrode and located in the reflective region. The electrophoretic display film is disposed on the substrate and includes a common electrode and multiple microcapsules disposed between the common electrode and the pixel units, in which each the microcapsule includes multiple black electrophoretic particles, and the arrangement of the black electrophoretic particles is controlled by a driving voltage applied between the pixel electrode of each the pixel unit and the common electrode of the electrophoretic display film.

### CROSS-REFERENCE TO RELATED APPLICATION

This application claims the priority benefit of Taiwan application serial no. 101109090, filed on Mar. 16, 2012. The entirety of the above-mentioned patent application is hereby incorporated by reference herein and made a part of this specification.

### BACKGROUND OF THE INVENTION

1. Field of the Invention

The invention generally relates to a display apparatus, and more particularly, to an electrophoretic display apparatus.

2. Description of Related Art

In recent years, since various display techniques continue to flourish, after ceaselessly researching and developing, many display products such as electrophoretic display, liquid crystal display (LCD), plasma display, organic light-emitting diode display (OLED display) have been gradually commercialized and applied in display apparatuses with various sizes and areas. With the growing popularity of portable electronic products, flexible displays such as electronic paper (e-paper), e-books (e-book), and so on have been gradually attractive by the customers on the market.

In general speaking, the e-paper and the e-book are based on electrophoretic display technique for the display purpose. Taking the e-book with black and white displayed colors as an example, the display medium thereof mainly includes a black electrophoretic liquid and white charged particles dispersed in the black electrophoretic liquid. After applying voltages on the medium, the white charged particles are driven to migrate so that each pixel respectively displays black color, white color or gray color with a gray level.

In the prior art, the electrophoretic display mostly utilizes light reflection of an external light source to achieve display purpose, while through driving the white charged particles dispersed in the electrophoretic liquid by applied voltages, each pixel can display with a required gray level. For expanding the application of the electrophoretic display, a color filter film is fabricated on the display medium and the color filter film is fixed on the display medium through an adhesive layer. At the time, after the external incident light passes through the color filter film, the external light is reflected by the white charged particles in the display medium and then penetrates the color filter film for displaying. That is to say, in the light transmission path, the light penetrates the color filter film twice, so that the efficiency of light transmission is degraded a lot and the colorful saturation and luminance performance of the electrophoretic display is affected.

### SUMMARY OF THE INVENTION

Accordingly, the invention is directed to an electrophoretic display apparatus able to have better display luminance and colorful saturation in addition to having energy-saving effect.

The embodiment of the invention provides an electrophoretic display apparatus, which includes a substrate and an electrophoretic display film. The substrate has a plurality of pixel units, in which each of the pixel units has a transparent region and a reflective region and each of the pixel units includes a pixel electrode and a reflective layer. The pixel electrode is located in the transparent region and the reflective region. The reflective layer is disposed on the pixel electrode and located in the reflective region. The electrophoretic display film is disposed on the substrate and includes a common electrode and a plurality of microcapsules disposed between the common electrode and the pixel units, in which each of the microcapsules includes a plurality of black electrophoretic particles, and an arrangement of the black electrophoretic particles is controlled by a driving voltage applied between the pixel electrode of each the pixel unit and the common electrode of the electrophoretic display film.

In an embodiment of the present invention, the above-mentioned electrophoretic display apparatus further includes a binder disposed between the common electrode and the substrate, in which the microcapsules are distributed in the binder.

In an embodiment of the present invention, the above-mentioned each of the microcapsules further includes an electrophoretic liquid and the black electrophoretic particles are distributed in the electrophoretic liquid.

In an embodiment of the present invention, the above-mentioned each of the microcapsules further includes a microcup structure and an electrophoretic liquid, the black electrophoretic particles are distributed in the electrophoretic liquid and the electrophoretic liquid and the black electrophoretic particles are enclosed in the microcup structure.

In an embodiment of the present invention, the above-mentioned electrophoretic display apparatus further includes a color filter film disposed on the common electrode of the electrophoretic display film.

In an embodiment of the present invention, the above-mentioned electrophoretic display apparatus further includes a transparent optical adhesive layer disposed between the binder of the electrophoretic display film and the substrate.

In an embodiment of the present invention, the above-mentioned electrophoretic display apparatus further includes a color filter film disposed between the binder of the electrophoretic display film and the substrate.

In an embodiment of the present invention, the above-mentioned electrophoretic display apparatus further includes a transparent optical adhesive layer disposed between the color filter film and the binder of the electrophoretic display film.

In an embodiment of the present invention, when a high-frequency AC voltage is applied between each the pixel electrode and the common electrode, the black electrophoretic particles are in a vertical arrangement so that a light penetrates the transparent regions to enter the electrophoretic display film for displaying.

In an embodiment of the present invention, when a low-frequency AC voltage or a DC voltage is applied between each the pixel electrode and the common electrode, the black electrophoretic particles are dispersedly arranged in the transparent region and the reflective region of each the pixel unit so that a light is unable to penetrate the electrophoretic display film.

In an embodiment of the present invention, a material of the pixel electrode includes indium oxide (IO), tin oxide (TO), indium tin oxide (ITO) or indium zinc oxide (IZO).

In an embodiment of the present invention, a material of the reflective layer includes metal or alloy.

In an embodiment of the present invention, a material of the reflective layer includes titanium dioxide.

Based on the description above, the pixel unit of the embodiment of the invention has a transparent region and a reflective region, in which the pixel electrode is disposed in the transparent region and the reflective region and the reflective layer is disposed on the pixel electrode and located in the reflective region. In this way, the arrangement of the black electrophoretic particles can be controlled by applying a driving voltage between the pixel electrode and the common electrode, so that a light (for example, a backlight source) can directly penetrate the pixel electrode located at the transparent region for displaying; or the light (for example, an external light) can penetrate the electrophoretic display film first and then is reflected by the reflective layer for displaying. In addition, since the light directly penetrating the transparent region has better optical performance of colorful saturation and display luminance, it can reinforce the optical performance of the light after the reflection and the electrophoretic display apparatus of the embodiment of the invention has better display luminance and colorful saturation.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic cross-sectional diagram of an electrophoretic display apparatus according to an embodiment of the invention.

FIG. 2 is a schematic cross-sectional diagram of another electrophoretic display apparatus according to an embodiment of the invention.

FIG. 3 is a schematic cross-sectional diagram of yet another electrophoretic display apparatus according to an embodiment of the invention.

### DESCRIPTION OF THE EMBODIMENTS

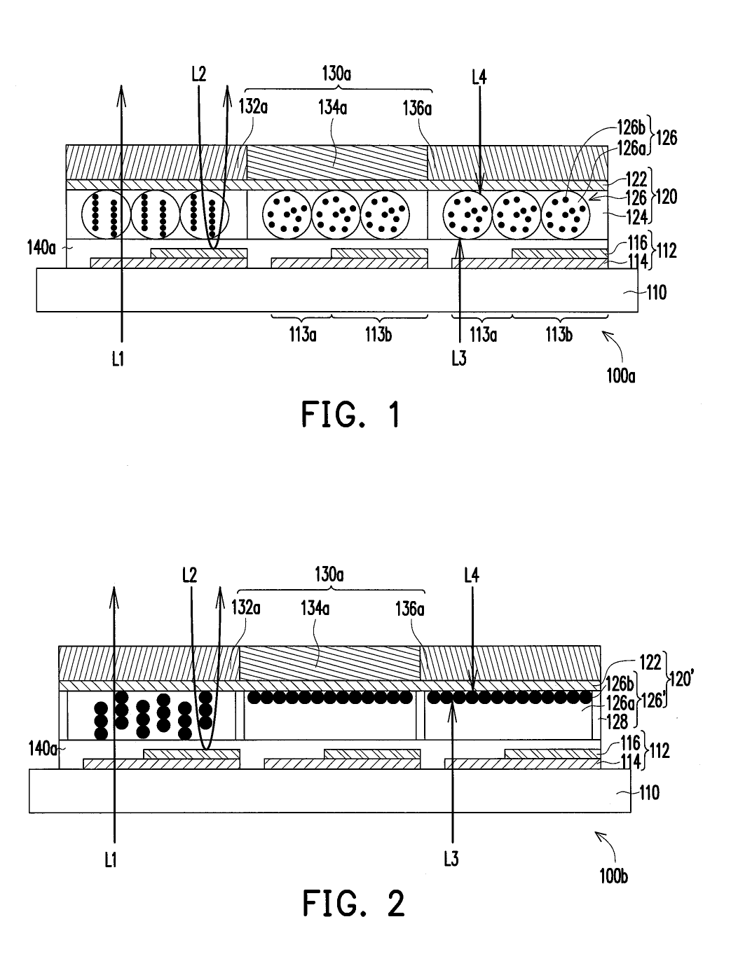

FIG. 1 is a schematic cross-sectional diagram of an electrophoretic display apparatus according to an embodiment of the invention. Referring to FIG. 1, an electrophoretic display apparatus 100a includes a substrate 110 and an electrophoretic display film 120.

In more details, the substrate 110 has a plurality of pixel units 112 (only three ones are shown in FIG. 1), in which each of the pixel units 112 has a transparent region 113a and a reflective region 113b. Each of the pixel units 112 includes a pixel electrode 114 and a reflective layer 116, in which the pixel electrode 114 is located in the transparent region 113a and the reflective region 113b, and the reflective layer 116 is disposed on the pixel electrode 114 and located in the reflective region 113b. That is to say the reflective region 113b is just the position where the reflective layer 116 is located at. The part of the pixel electrode 114 uncovered by the reflective layer 116 is the position of the transparent region 113a.

It should be noted that the substrate 110 of the embodiment is, for example, an active array substrate and each of the pixel units 112 further includes an active device (not shown), in which the active device is electrically connected to the pixel electrode 114 and located under the reflective layer 116. The material of the pixel electrode 114 is, for example, indium oxide (IO), tin oxide (TO), indium tin oxide (ITO) or indium zinc oxide (IZO), which the invention is not limited to. The material of the reflective layer 116 can be metal, for example, aluminium or alloy such as aluminium alloy. The material of the reflective layer 116 can certainly be a material with high reflectivity, for example, titanium dioxide. The above-mentioned materials of the reflective layer 116 are examples only, which the invention is not limited to. In fact, as long as a material has reflection function, the material can be used for the reflective layer 116 and belongs to the technical scheme adopted by the invention without departing from the claimed scope of the invention.

The electrophoretic display film 120 is disposed on the substrate 110 and includes a common electrode 122 and a plurality of microcapsules 126. In more details, the microcapsules 126 are disposed between the common electrode 122 and the pixel units 112. Each of the microcapsules 126 includes an electrophoretic liquid 126a and a plurality of black electrophoretic particles 126b, in which the black electrophoretic particles 126b are distributed in the electrophoretic liquid 126a and the black electrophoretic particles 126b are, for example, opaque black charged particles. The electrophoretic display film 120 further includes a binder 124 disposed between the common electrode 122 and the substrate 110 and the microcapsules 126 are distributed in the binder 124.

In addition, the electrophoretic display apparatus 100a of the embodiment further includes a color filter film 130a and a transparent optical adhesive layer 140a. The color filter film 130a is disposed on the common electrode 122 of the electrophoretic display film 120, and the color filter film 130a includes a plurality of red filter units 132a (only one is shown in FIG. 1), a plurality of green filter units 134a (only one is shown in FIG. 1) and a plurality of blue filter units 136a (only one is shown in FIG. 1). The color filter film 130a is configured for the electrophoretic display apparatus 100a to display colorful image so as to expand the application scope thereof. The transparent optical adhesive layer 140a is disposed between the binder 124 of the electrophoretic display film 120 and the substrate 110, in which the electrophoretic display film 120 is fixed onto the substrate 110 through the transparent optical adhesive layer 140a.

In particular in the embodiment, the arrangement of the black electrophoretic particles 126b is controlled by a driving voltage applied between the pixel electrode 114 of each of the pixel units 112 and the common electrode 122 of the electrophoretic display film 120. In more details, when a high-frequency AC voltage is applied between each the pixel electrode 114 and the common electrode 122, the black electrophoretic particles 126b are in a vertical arrangement (referring to the arrangement of the black electrophoretic particles 126b under the red filter unit 132a in FIG. 1) so that a light L1 can penetrate the transparent regions 113a to enter the electrophoretic display film 120 for displaying. Meanwhile, another light L2 penetrates the electrophoretic display film 120 and then is reflected by the reflective layer 116 of the substrate 110 for displaying. At the time, the pixel unit 112 is in bright optical state.

When a low-frequency AC voltage or a DC voltage is applied between each the pixel electrode 114 and the common electrode 122, the black electrophoretic particles 126b are dispersedly arranged in the transparent region 113a and the reflective region 113b of each the pixel unit 112 so that a light is unable to penetrate the electrophoretic display film (referring to the arrangement of the black electrophoretic particles 126b under the green filter unit 134a or under the blue filter unit 136a in FIG. 1) so that a light L3 and another light L4 are unable to penetrate the electrophoretic display film 120 for displaying. At the time, the pixel unit 112 is in dark optical state. It should be noted that the above-mentioned lights L1 and L3 are the lights come from a backlight source (not shown), while L2 and L4 are outside ambient lights.

Since the light L1 directly penetrating the transparent region 113a has better optical performance of colorful saturation and display luminance, it can reinforce the optical performance of the light L2 after the reflection. Hence in comparison with the prior art where the electrophoretic display apparatus produces displaying by the reflection of light only, the electrophoretic display apparatus 100a of the embodiment has better display luminance and colorful saturation. In short, the electrophoretic display apparatus 100a of the embodiment achieves the goal of controlling the distribution of the black electrophoretic particles 126b through a transflective design and the driving voltage so as to improve the poor optical performance of the conventional electrophoretic display where the displaying is produced by the reflection of light only and the colorful saturation and the luminance are insufficient. In addition, when the intensity of the outside ambient light (for example, the light L2 or L4) is high enough, the backlight source (for example, the light L1 or L3) can be shut off to save energy.

FIG. 2 is a schematic cross-sectional diagram of another electrophoretic display apparatus according to an embodiment of the invention. It should be noted the component notations and partial details of the structures hereinafter provided in the embodiments can be the same as or similar to the previous embodiment, wherein the same notations represent the same or similar components while the repeated same details are omitted, which can refer to the previous embodiment.

Referring to FIG. 2, the electrophoretic display apparatus 100b of the embodiment is similar to the electrophoretic display apparatus 100a of the above-mentioned embodiment except that each microcapsule 126′ of the electrophoretic display film 120′ includes an electrophoretic liquid 126a, a plurality of black electrophoretic particles 126b and a microcup structure 128, in which the microcup structure 128 is joined between the transparent optical adhesive layer 140a and the common electrode 122 so as to enclose the electrophoretic liquid 126a and the black electrophoretic particles 126b into the microcup structure 128.

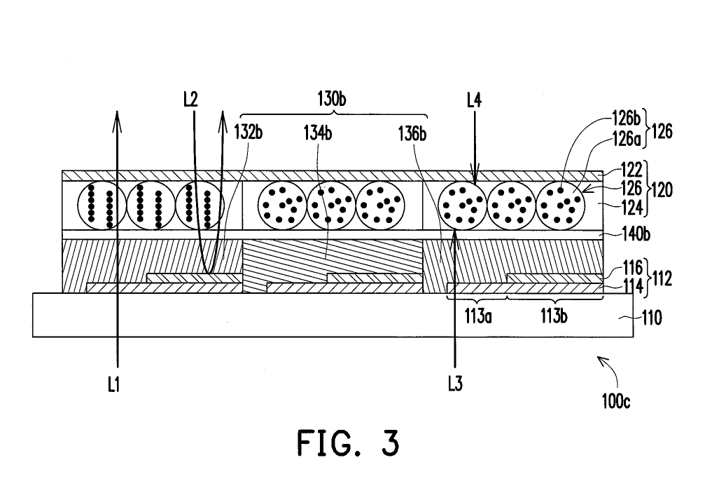

FIG. 3 is a schematic cross-sectional diagram of yet another electrophoretic display apparatus according to an embodiment of the invention. It should be noted the component notations and partial details of the structures hereinafter provided in the embodiments can be the same as or similar to the previous embodiment, wherein the same notations represent the same or similar components while the repeated same details are omitted, which can refer to the previous embodiment.

Referring to FIG. 3, the electrophoretic display apparatus 100c of the embodiment is similar to the electrophoretic display apparatus 100a of the above-mentioned embodiment except that the disposing positions of the color filter film 130b and the transparent optical adhesive layer 140b are different from the disposing positions of the color filter film 130a and the transparent optical adhesive layer 140a. In more details, the color filter film 130b is disposed between the binder 124 of the electrophoretic display film 120 and the substrate 110 and covers the reflective layer 116 and the pixel electrode 114. The transparent optical adhesive layer 140b is disposed between the color filter film 130b and the binder 124 of the electrophoretic display film 120 so as to fix the electrophoretic display film 120 onto the color filter film 130b.

In summary, the pixel unit of the embodiment of the invention has a transparent region and a reflective region, in which the pixel electrode is disposed in the transparent region and the reflective region and the reflective layer is disposed on the pixel electrode and located in the reflective region. In this way, the arrangement of the black electrophoretic particles can be controlled by applying a driving voltage between the pixel electrode and the common electrode, so that a light (for example, a backlight source) can directly penetrate the pixel electrode located at the transparent region for displaying; or the light (for example, an external light) can penetrate the electrophoretic display film first and then is reflected by the reflective layer for displaying. In addition, since the light directly penetrating the transparent region has better optical performance of colorful saturation and display luminance, it can reinforce the optical performance of the light after the reflection and the electrophoretic display apparatus of the embodiment of the invention has better display luminance and colorful saturation.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An electrophoretic display apparatus, comprising:
a substrate, having a plurality of pixel units, wherein each of the pixel units has a transparent region and a reflective region and each of the pixel units comprises:
a pixel electrode, located in the transparent region and the reflective region; and
a reflective layer, disposed on the pixel electrode and located in the reflective region; and
an electrophoretic display film, disposed on the substrate and the electrophoretic display film comprising:
a common electrode; and
a plurality of microcapsules, disposed between the common electrode and the pixel units, wherein each of the microcapsules comprises a plurality of black electrophoretic particles, and an arrangement of the black electrophoretic particles is controlled by a driving voltage applied between the pixel electrode of each the pixel unit and the common electrode of the electrophoretic display film.

2. The electrophoretic display apparatus as claimed in claim 1, further comprising a binder disposed between the common electrode and the substrate, wherein the microcapsules are distributed in the binder.

3. The electrophoretic display apparatus as claimed in claim 2, wherein each of the microcapsules further comprises an electrophoretic liquid, wherein the black electrophoretic particles are distributed in the electrophoretic liquid.

4. The electrophoretic display apparatus as claimed in claim 1, wherein each of the microcapsules further comprises a microcup structure and an electrophoretic liquid, the black electrophoretic particles are distributed in the electrophoretic liquid and the electrophoretic liquid and the black electrophoretic particles are enclosed in the microcup structure.

5. The electrophoretic display apparatus as claimed in claim 1, further comprising a color filter film disposed on the common electrode of the electrophoretic display film.

6. The electrophoretic display apparatus as claimed in claim 5, further comprising a transparent optical adhesive layer disposed between the binder of the electrophoretic display film and the substrate.

7. The electrophoretic display apparatus as claimed in claim 1, further comprising a color filter film disposed between the binder of the electrophoretic display film and the substrate.

8. The electrophoretic display apparatus as claimed in claim 7, further comprising a transparent optical adhesive layer disposed between the color filter film and the binder of the electrophoretic display film.

9. The electrophoretic display apparatus as claimed in claim 1, wherein when a high-frequency AC voltage is applied between each the pixel electrode and the common electrode, the black electrophoretic particles are in a vertical arrangement so that a light penetrates the transparent regions to enter the electrophoretic display film for displaying.

10. The electrophoretic display apparatus as claimed in claim 1, wherein when a low-frequency AC voltage or a DC voltage is applied between each the pixel electrode and the common electrode, the black electrophoretic particles are dispersedly arranged in the transparent region and the reflective region of each the pixel unit so that a light is unable to penetrate the electrophoretic display film.

11. The electrophoretic display apparatus as claimed in claim 1, wherein a material of the pixel electrode comprises indium oxide (IO), tin oxide (TO), indium tin oxide (ITO) or indium zinc oxide (IZO).

12. The electrophoretic display apparatus as claimed in claim 1, wherein a material of the reflective layer comprises metal or alloy.

13. The electrophoretic display apparatus as claimed in claim 1, wherein a material of the reflective layer comprises titanium dioxide.
